(19) United States
(12) Patent Application Publication
(10) Pub. No.: US 2018/0075434 A1
(43) Pub. Date: Mar. 15, 2018

(54) CARD REPLACEMENT SYSTEMS AND METHOD

(71) Applicant: Tanner Joseph Supernault, Dawson Creek (CA)

(72) Inventor: Tanner Joseph Supernault, Dawson Creek (CA)

(21) Appl. No.: 15/266,879

(22) Filed: Sep. 15, 2016

(51) Int. Cl. G06Q 20/32; H04L 29/06; H04W 12/06; G06Q 20/40

(52) U.S. Cl. CPC G06Q 20/322; G06Q 20/40145; H04W 12/06; H04L 63/0861

(57) ABSTRACT

A card replacement system for organizing personal identification and financial information eliminating the need for individuals to carry these documents. The system contains all personal identification information which can be accessed and provided when necessary. Financial information loaded into the system permits bill pay and tracks limits/balances on credit cards. The system further offers smart appliance control, vehicle control, and other options for every day purchases such as airline/movie theater tickets. Vehicle functions include remote start, and climate control as well as keyless entry.

### BACKGROUND OF THE DISCLOSURE

The following includes information that may be useful in understanding the present disclosure(s). It is not an admission that any of the information provided herein is prior art, or material, to the presently described or claimed disclosures, or that any publication or document that is specifically or implicitly referenced is prior art.

### 1. Field of the Disclosure

The present disclosure relates generally to the field of information organization and more specifically relates to a personal information organization system.

### 2. Description of Related Art

A mobile application is a computer program designed to run on smartphones, tablet computers and other mobile devices. Mobile applications were originally offered for general productivity and information retrieval, including email, calendar, contacts, and stock market and weather information. However, public demand and the availability of developer tools drove rapid expansion into other categories, such as mobile games, factory automation, GPS and location-based services, banking, order-tracking, ticket purchases and recently mobile medical applications. The explosion in number and variety of applications made discovery a challenge, which in turn led to the creation of a wide range of review, recommendation, and curation sources, including blogs, magazines, and dedicated online application-discovery services. Many new applications are desirable to provide convenient solutions to the users.

Several attempts have been made to solve the above-mentioned problems such as those found in U.S. Pub. Nos. 2012/0278865 to Kip Sawdy; 2014/0195424 to Yu Zheng et al.; 2010/0260388 to Peter Garrett et al., U.S. Pat No. 8,733,648 to Anastasia Melbrod et al.; U.S. Pat. No. 7,708,194 to Jamison Vawter, Foreign Pat Nos. WO 2012/151486 to Kathleen Phillips et al.; WO 2014/099819 to Gilbert R. Ortega et al.; and CA 2,650,852 to Sean Moshier et al. This art is representative of information organization. However, none of the above disclosures and patents, taken either singly or in combination, is seen to describe the disclosure as claimed.

### BRIEF SUMMARY OF THE DISCLOSURE

In view of the foregoing disadvantages inherent in the known information organization art, the present disclosure provides a novel personal information organization system. The general purpose of the present disclosure, which will be described subsequently in greater detail is to provide a card replacement system.

A system for securing and applying user information, such as the card replacement system is disclosed herein, in a preferred embodiment, comprising a mobile device housing, a transceiver embedded in the mobile device housing and configured to communicate over a wireless communication link, memory embedded in the mobile device housing, and configured to store an executable mobile application, the executable mobile application configured to secure personal information of a user, and to subsequently verify the user has authorized access to and further use of the executable mobile application. Card replacement system may have permission to execute a bill pay option, the bill pay option communicating the personal information and command information over the wireless communication link via the transceiver to complete a financial transaction. Card replacement system may have permission to execute a household appliance control option, the household appliance control option communicating an authorization information and appliance control information over the wireless communication link via the transceiver to modify operation of a household appliance.

The memory may further include a removable memory device configured to store portable data associated with the mobile application; a processor embedded in the housing and communicably coupled to the transceiver, the memory, and the user interface, the processor configured to execute the executable mobile application responsive to the user interaction with the user interface and verify the user is authorized access to and further use of the executable mobile application. Users may selectably execute the bill pay option, execute a household appliance control option, thereby communicating the personal information and command information over the wireless communication link via the transceiver, thereby communicating the authorization information and appliance control information over the wireless communication link via the transceiver. A user interface may be fixed to the mobile device housing and may include a biometric scanner, a secure login matrix, and a manual data entry subsystem. Further, the biometric scanner and the secure log in matrix may be configured to challenge user-authorization, the secure log-in matrix having at least a 256-bit-encryption protocol, and manual data entry subsystem configured to provide for the user to input information in the system manually.

A smart appliance scanner may be configured to scan and locate a smart appliance to operate. The smart appliance communication link may be configured to communicably couple with the smart appliance and provide for remote control of the smart appliance. A camera document logging subsystem may be configured to digitize and index a photo of a document. The executable mobile application is further configured to execute a vehicle remote start function, the vehicle remote start function communicating the vehicle start authorization information and vehicle control information over the wireless communication link via the transceiver to modify operation of the vehicle. The vehicle control information includes commands to start the vehicle and to operate climate controls of the vehicle, and may further include commands to initiate preset GPS location service selections, provide keyless vehicle entry, and a vehicle fob duplication option. The app is able to connect to a television to set times for television shows to be recorded or turned on when the user gets home, and vehicles, dishwashers, coffee machines, radio stations, etc., also can be set on a timer so when the user wakes up at 6:30 for example their vehicle is able to start at 7:00 when the user needs the vehicle warmed. Home doors, garage doors all doors lights as well are able to be manipulated. Bit coins are able to be able to work with this system as well, as a form of payment.

The camera document logging subsystem saves the document in a PDF format and automatically optically recognizes text in the photo and may save a text image as text. The bill pay protocol may permit automatic revolving monthly budget payments, credit card balance notifications, and mobile banking management for managing multiple banking institutions. The biometric scanner may enable stored retinal recognition identification, stored finger print recognition identification. Further, the secure log in matrix may have a voice recognition algorithm to recognize a primary user vocal tone, and may provide voice command controls for hands free operation. The card replacement system provides a secure personal identification digital locker for storing passports, birth certificates and the like, while simultaneously provides access to personal credit cards alleviating the need to carry personal credit cards and identification.

According to another embodiment, a method for using the card replacement system is also disclosed herein. The method for providing an application to replace credit cards and personal identification includes the steps of: purchasing the card replacement system as an executable mobile application, input personal identification and credit card information into the executable mobile application, and setting/denying access to specific users.

The present disclosure holds significant improvements and serves as personal information organization system. Preferably, an information organization should provide a card replacement system and, yet would operate reliably and be manufactured at a modest expense. Thus, a need exists for a reliable personal information organization system to avoid the above-mentioned problems.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or carried out in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### BRIEF DESCRIPTION OF THE DRAWINGS

The figures which accompany the written portion of this specification illustrate embodiments and method(s) of use for the present disclosure, card replacement systems, constructed and operative according to the teachings of the present disclosure.

FIG. 1 shows a perspective view illustrating a card replacement system during an ‘in-use’ condition according to an embodiment of the disclosure.

FIG. 2 is a perspective view illustrating the card replacement system comprising a mobile device and executable mobile application assembly according to an embodiment of the present disclosure of the disclosure.

FIG. 3 is a perspective view illustrating the mobile device and executable mobile application assembly according to an embodiment of the present disclosure.

FIG. 4 is a perspective view illustrating the mobile device and executable mobile application assembly according to an embodiment of the present disclosure.

FIG. 5 is a flow diagram illustrating a method of use for the card replacement system according to an embodiment of the present disclosure.

The various embodiments of the present disclosure will hereinafter be described in conjunction with the appended drawings, wherein like designations denote like elements.

### DETAILED DESCRIPTION

As discussed above, embodiments of the present disclosure relate to information organization and more particularly to a personal information organization system as used to improve the card replacement system.

Generally speaking, card replacement system substitutes the cards and devices used every day. The system secures personal information such as driver license data, passports, birth certificates, social security cards, student identification, etc. The information from some of these items can be input using the barcode scanner. Financial information from mortgage to credit cards can also be managed by the system permitting bill payments, and providing credit card balance notifications. Vehicle control functions and keyless entry are incorporated to reduce the chances of vehicle lock out. Permissions for each user can be set by a master user, and the master user can monitor each user's activity. The system can be locked with a biometric scanner which can read a finger print, retinal scan, voice print identification, etc.

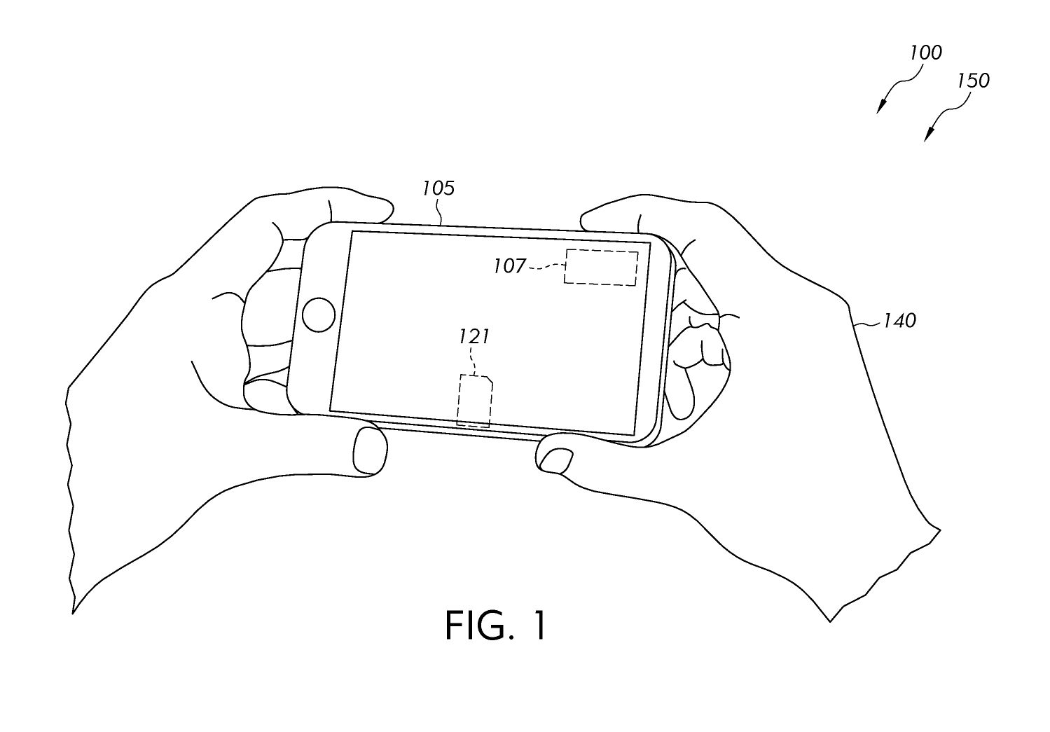

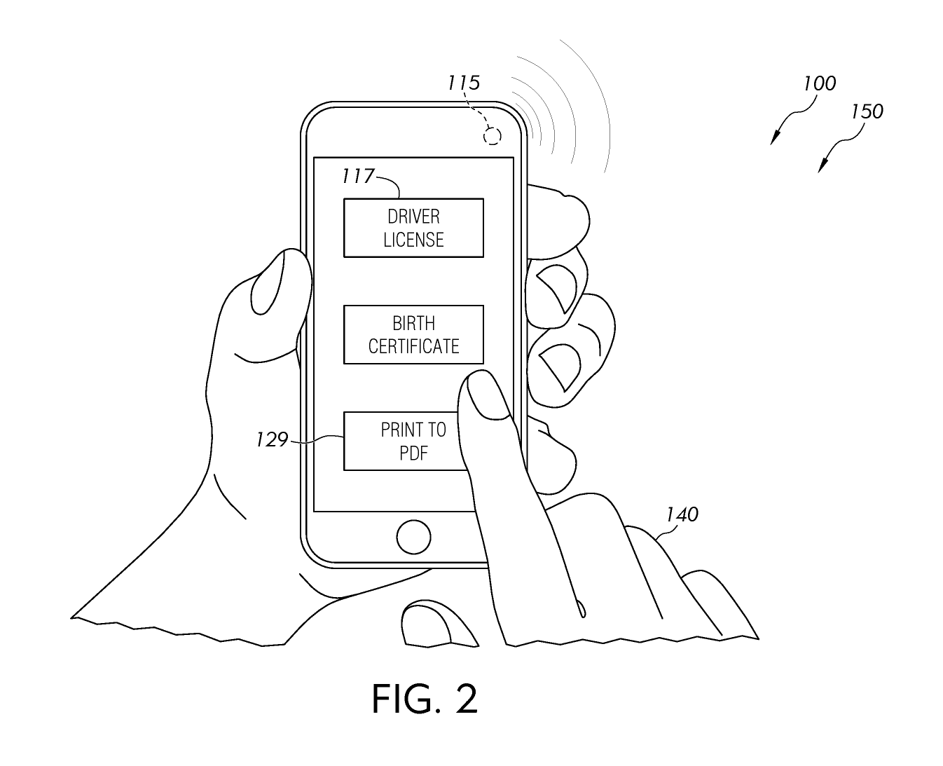

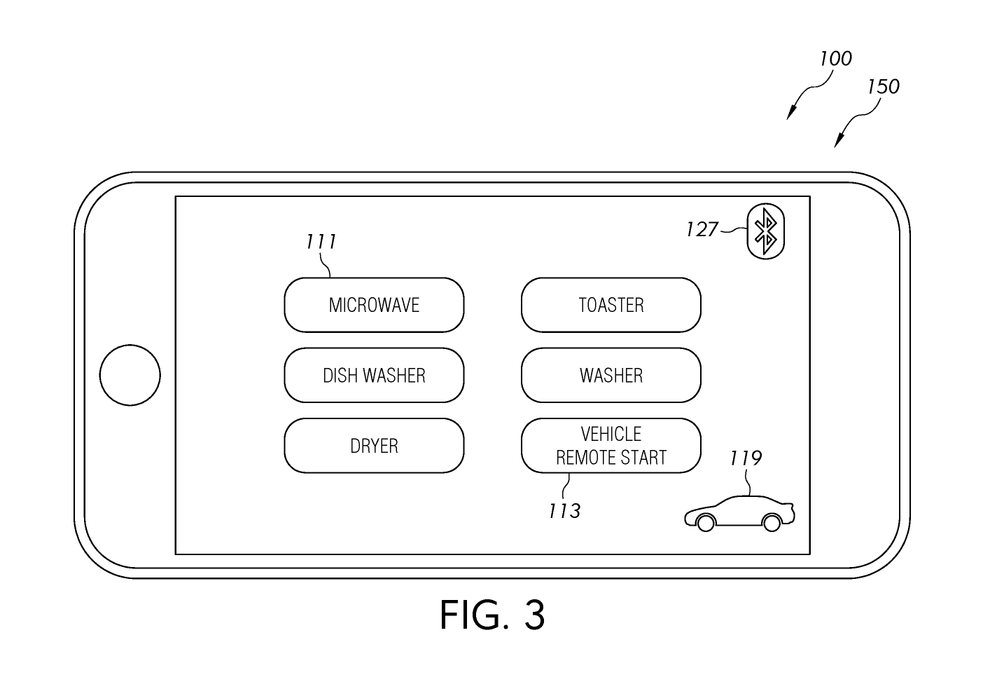

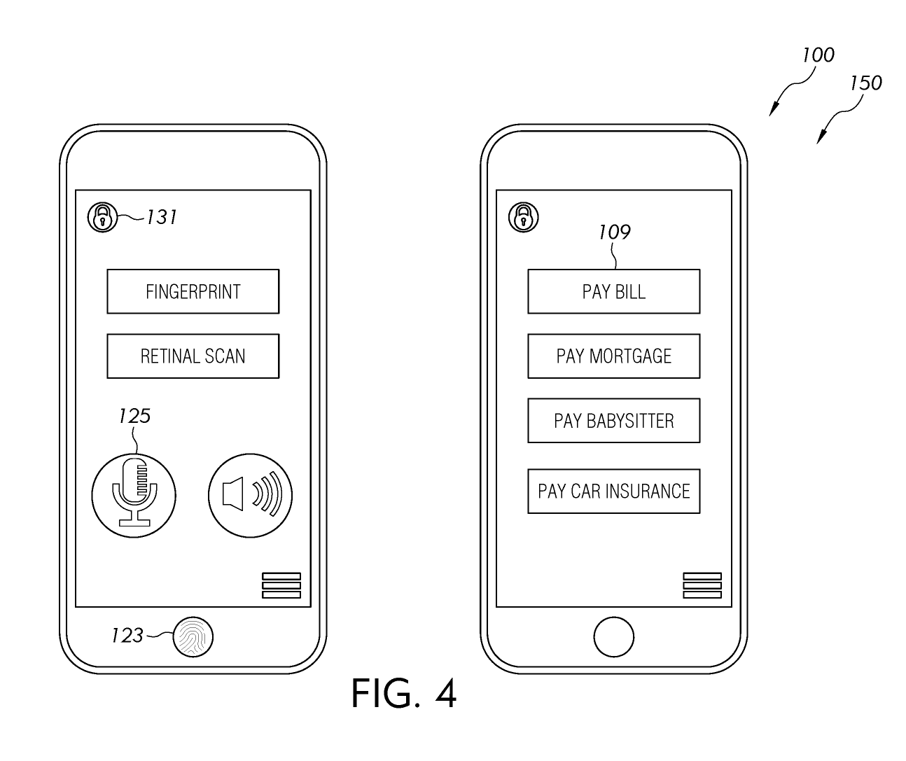

Referring now more specifically to the drawings by numerals of reference, FIGS. 1-4 show a system for securing and applying user information, such as card replacement system 100 comprising: mobile device housing 105; a transceiver embedded in mobile device housing 105 and configured to communicate over wireless communication link 115; memory 107 embedded in mobile device housing 105, and configured to store an executable mobile application. The executable mobile application may be configured to secure personal information 117 of user 140, and to subsequently verify user 140 is authorized access to and further use of the executable mobile application. Card replacement system 100 may have permission to execute bill pay option 109, bill pay option 109 communicating personal information 117 and command information over wireless communication link 115 via the transceiver to complete a financial transaction. Further, the bill pay protocol may permit automatic revolving monthly budget payments, credit card balance notifications, and mobile banking management for managing multiple banking institutions.

Card replacement system 100 may have permission to execute household appliance control option 111, household appliance control option 111 communicating authorization information and appliance control information over wireless communication link 115 via the transceiver to modify operation of a household appliance. Card replacement system 100 may have permission to execute vehicle remote start function 113, vehicle remote start function 113 communicating vehicle start authorization information and vehicle control information over wireless communication link 115 via the transceiver to modify operation of a vehicle 119. Vehicle control information may further include commands to start the vehicle and to operate climate controls of the vehicle, initiate preset GPS location service selections, and provide keyless vehicle entry, wherein the keyless vehicle entry includes a vehicle fob duplication option.

Memory 107 may further include removable memory device 121 configured to store portable data associated with the mobile application. A processor may be embedded in mobile device housing 105 and communicably coupled to the transceiver, memory 107, and the user interface, such that the processor may be configured to execute the executable mobile application. Card replacement system 100 may be responsive to user 140 interaction with user 140 interface, and verify user 140 is authorized access to and further use of the executable mobile application. A user 140 may selectably execute bill pay option 109, and household appliance control option 111, to communicate personal information 117 and command information over the wireless communication link 115 via the transceiver, and to further communicate the authorization information and appliance control information over the wireless communication link 115 via the transceiver. User 140 interface may be fixed to mobile device housing 105 and may include biometric scanner 123, a secure login matrix, and a manual data entry subsystem. Biometric scanner 123 and the secure log in matrix may be configured to challenge user-authorization, with the secure log-in matrix having at least a 256-bit-encryption protocol, and manual data entry subsystem configured to provide for user 140 to input information in the system manually. Biometric scanner 123 may enable stored retinal recognition identification, and finger print recognition identification.

The secure log in matrix may have a voice recognition algorithm 125 to recognize a primary user 140 vocal tone, and may further provide voice command controls for hands free operation. The smart appliance scanner 127 may be configured to scan and locate a smart appliance to operate; then, communicably couple with the smart appliance and provide for remote control of the smart appliance. The camera document logging subsystem may be configured to digitize and index a photo of a document, and further saves the document in a PDF 129 format. Additionally, the camera document logging subsystem automatically optically recognizes text in the photo and saves a text image as text. Card replacement system 100 may provide a secure personal identification digital locker 131 for storing passports, birth certificates and the like; further, the personal identification digital locker 131 provides access to personal credit cards alleviating the need to carry personal credit cards and identification.

Card replacement system 100 may be sold as a kit comprising the following parts: at least one executable mobile application; and at least one set of user instructions. The kit has instructions such that functional relationships are detailed in relation to the structure of the disclosure (such that the disclosure can be used, maintained, or the like in a preferred manner).

Card replacement system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

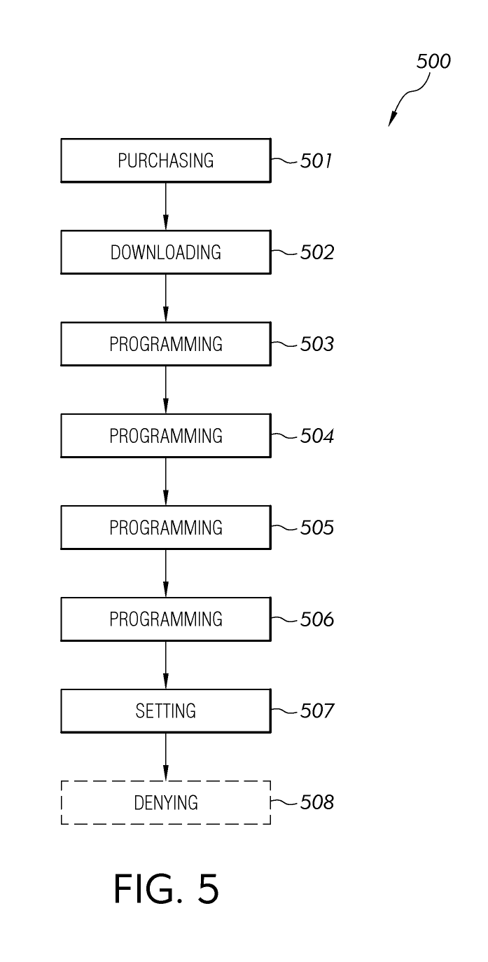

Referring now to FIG. 5 showing a flow diagram 550 illustrating method of use 500 for card replacement system 100 according to an embodiment of the present disclosure of FIGS. 1-4. As shown, method of use 500 may comprise the steps of: step one 501, purchasing an executable mobile application for securing and applying user information; step two 502, downloading the executable mobile application for securing and applying user information; step three 503, programming the executable mobile application for securing and applying user information with personal data; step four 504, programming the executable mobile application for securing and applying user information with appliance data; step five 505, programming the executable mobile application for securing and applying user information with vehicle data; step six 506, programming the executable mobile application for securing and applying user information with financial data; step seven 507, setting permissions through the executable mobile application for securing and applying user information; and step eight 508, denying access to a specific user.

It should be noted that step 508 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A system for securing and applying user information, the system comprising:
a mobile device housing;
a transceiver embedded in the mobile device housing and configured to communicate over a wireless communication link;
a memory embedded in the mobile device housing, and configured to store an executable mobile application, the executable mobile application configured
to secure a personal information of a user,
to subsequently verify the user is authorized access to and further use of said executable mobile application,
to execute a bill pay option, said bill pay option communicating the personal information and command information over the wireless communication link via the transceiver to effect a financial transaction, and
to execute a household appliance control option, said household appliance control option communicating an authorization information and appliance control information over the wireless communication link via the transceiver to modify operation of a household appliance,
the memory further including a removable memory device configured to store portable data associated with the mobile application;
a processor embedded in the housing and communicably coupled to the transceiver, the memory, and the user interface, the processor configured
to execute the executable mobile application responsive to said user interaction with the user interface and verify the user is authorized access to and further use of said executable mobile application,
to selectably execute said bill pay option,
to selectably execute a household appliance control option,
to communicate the personal information and command information over the wireless communication link via the transceiver, and
to communicate the authorization information and appliance control information over the wireless communication link via the transceiver;
a user interface fixed to the mobile device housing and including a biometric scanner, a secure login matrix, and a manual data entry subsystem, the biometric scanner and the secure log in matrix configured to challenge user-authorization, the secure log-in matrix having at least a 256-bit-encryption protocol, and manual data entry subsystem configured to provide for the user to input information in the system manually;
a smart appliance scanner configured to scan and locate a smart appliance to operate;
a smart appliance communication link configured to communicably couple with the smart appliance and provide for remote control of said smart appliance; and
a camera document logging subsystem configured to digitize and index a photo of a document.

2. The system of claim 1, wherein said executable mobile application is further configured to execute a vehicle remote start function, said vehicle remote start function communicating a vehicle start authorization information and vehicle control information over the wireless communication link via the transceiver to modify operation of a vehicle.

3. The system of claim 2, wherein said vehicle control information includes commands to start the vehicle and to operate climate controls of said vehicle.

4. The system of claim 2, wherein said vehicle control information includes commands to start the vehicle and to initiate preset GPS location service selections.

5. The system of claim 1, wherein said vehicle control information includes commands to start the vehicle and to provide keyless vehicle entry.

6. The system of claim 5, wherein said keyless vehicle entry includes a vehicle fob duplication option.

7. The system of claim 1, wherein said camera document logging subsystem saves the document in a PDF format and automatically optically recognizes text in the photo and saves a text image as text.

8. The system of claim 1, wherein said bill pay protocol permits automatic revolving monthly budget payments.

9. The system of claim 8, wherein said bill pay protocol provides credit card balance notifications.

10. The system of claim 9, wherein said bill pay protocol allows mobile banking management for managing multiple banking institutions.

11. The system of claim 1, wherein said biometric scanner enables stored retinal recognition identification.

12. The system of claim 11, wherein said biometric scanner enables stored finger print recognition identification.

13. The system of claim 1, wherein said secure log in matrix having a voice recognition algorithm to recognize a primary user vocal tone.

14. The system of claim 13, wherein said voice recognition algorithm provides voice command controls for hands free operation.

15. The system of claim 1, wherein said system provides a secure personal identification digital locker for storing passports, birth certificates and the like.

16. The system of claim 1, wherein said personal identification digital locker provides access to personal credit cards alleviating carrying of said personal credit cards.

17. A system for securing and applying user information comprising:
a mobile device housing;
a transceiver embedded in the mobile device housing and configured to communicate over a wireless communication link;
a memory embedded in the mobile device housing, and configured to store an executable mobile application, the executable mobile application configured
to secure a personal information of a user,
to subsequently verify the user is authorized access to and further use of said executable mobile application,
to execute a bill pay option, said bill pay option communicating the personal information and command information over the wireless communication link via the transceiver to effect a financial transaction,
wherein said bill pay protocol permits automatic revolving monthly budget payments,
wherein said bill pay protocol provides credit card balance notifications,
wherein said bill pay protocol allows mobile banking management for managing multiple banking institutions,
to execute a household appliance control option, said household appliance control option communicating an authorization information and appliance control information over the wireless communication link via the transceiver to modify operation of a household appliance,
to execute a vehicle remote start function, said vehicle remote start function communicating a vehicle start authorization information and vehicle control information over the wireless communication link via the transceiver to modify operation of a vehicle,
wherein said vehicle control information includes commands to start the vehicle and to operate climate controls of said vehicle,
wherein said vehicle control information includes commands to start the vehicle and to initiate preset GPS location service selections,
wherein said vehicle control information includes commands to start the vehicle and to provide keyless vehicle entry,
wherein said keyless vehicle entry includes a vehicle fob duplication option,
the memory further including a removable memory device configured to store portable data associated with the mobile application;
a processor embedded in the housing and communicably coupled to the transceiver, the memory, and the user interface, the processor configured
to execute the executable mobile application responsive to said user interaction with the user interface and verify the user is authorized access to and further use of said executable mobile application,
to selectably execute said bill pay option,
to selectably execute a household appliance control option,
to communicate the personal information and command information over the wireless communication link via the transceiver, and
to communicate the authorization information and appliance control information over the wireless communication link via the transceiver;
a user interface fixed to the mobile device housing and including a biometric scanner, a secure login matrix, and a manual data entry subsystem, the biometric scanner and the secure log in matrix configured to challenge user-authorization, the secure log-in matrix having at least a 256-bit-encryption protocol, and manual data entry subsystem configured to provide for the user to input information in the system manually;
wherein said biometric scanner enables stored retinal recognition identification,
wherein said biometric scanner enables stored finger print recognition identification,
wherein said secure log in matrix having a voice recognition algorithm to recognize a primary user vocal tone,
wherein said voice recognition algorithm provides voice command controls for hands free operation,
a smart appliance scanner configured to scan and locate a smart appliance to operate;
a smart appliance communication link configured to communicably couple with the smart appliance and provide for remote control of said smart appliance; and
a camera document logging subsystem configured to digitize and index a photo of a document,
wherein said camera document logging subsystem saves the document in a PDF format and automatically optically recognizes text in the photo and saves a text image as text,
wherein said system provides a secure personal identification digital locker for storing passports, birth certificates and the like, and
wherein said personal identification digital locker provides access to personal credit cards alleviating carrying of said personal credit cards.

18. The system for securing and applying user information of claim 17 further comprising a kit including:
an executable mobile application, and
a set of user instructions.

19. A method of using a system for securing and applying user information comprising the steps of:
purchasing an executable mobile application for securing and applying user information,
downloading the executable mobile application for securing and applying user information,
programming the executable mobile application for securing and applying user information with personal data,
programming the executable mobile application for securing and applying user information with appliance data,
programming the executable mobile application for securing and applying user information with vehicle data,
programming the executable mobile application for securing and applying user information with financial data, and
setting permissions through the executable mobile application for securing and applying user information.

20. The method of claim 19 further comprising the step of: denying access to a specific user.
